(19) United States
(12) Patent Application Publication
(10) Pub. No.: US 2010/0265554 A1
(43) Pub. Date: Oct. 21, 2010

(54) HOLOGRAM REPRODUCING AND IMAGING APPARATUS, AND HOLOGRAM REPRODUCING AND IMAGING METHOD

(75) Inventors: Akira Shirakura, Tokyo (JP); Koji Ishiwata, Kanagawa (JP); Fumihisa Kishibata, Shizuoka (JP); Yoshihiro Suigiura, Shizuoka (JP); Shigeyuki Baba, Tokyo (JP); Shinichi Yoshimura, Tokyo (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignees: SONY CORPORATION, Tokyo (JP); SONY DISC & DIGITAL SOLUTIONS INC., Tokyo (JP)

(21) Appl. No.: 12/759,230

(22) Filed: Apr. 13, 2010

(30) Foreign Application Priority Data
Apr. 20, 2009 (JP) 2009-101516

(51) Int. Cl. G03H 1/22

(52) U.S. Cl. 359/32

(57) ABSTRACT

A hologram reproducing and imaging apparatus includes a reference light source configured to be arranged near a hologram recording material on which a hologram is recorded and has an arrangement of a plurality of light sources, a reference light source drive section configured to drive the plurality of light sources in a time-division manner, an imaging sensor configured to capture an image of a reproduction area irradiated with reference light from the reference light source and photoelectrically convert the image, and an image processing section configured to process an imaging signal from the imaging sensor. Partial captured images are obtained by enabling the imaging signal of the area irradiated when the plurality of light sources are turned on, and the partial captured images are combined to be a reproduction image by the image processing section.

### BACKGROUND OF THE INVENTION

1. Field of the Invention

The present invention relates to a hologram reproducing and imaging apparatus and a hologram reproducing and imaging method for reproducing recorded information from a hologram recording material on which interference fringes of signal light (object light) and reference light are recorded, and photoelectrically converting the information.

2. Description of the Related Art

The hologram which can display a three-dimensional image is used to determine authenticity of a credit card, an identification card, and the like. Currently, many embossed type holograms, which record information by using surface unevenness of an interference film, are used. However, there is a problem that the embossed type hologram can be easily forged. On the other hand, a Lippmann type hologram which records information by using differences in refractive index in an interference film is very difficult to forge. This is because a sophisticated technique is used to record an image, and also recording material is difficult to obtain. As a producing method of the Lippmann type hologram, there are a real-scene hologram in which a laser is applied to an object, and a holographic stereogram in which information is recorded on the basis of parallax images from a plurality of viewpoints.

A producing process of the Lippmann type holographic stereogram generally includes an image obtaining process, a content producing process including editing processing of the obtained image, a hologram original plate manufacturing process, and a copying (mass-production) process. The image is obtained by image capturing or computer graphics. Each of a plurality of images obtained in the image editing process is converted into a strip-shaped image by, for example, a cylindrical lens. Interference fringes of the object light and the reference light of the image are sequentially recorded on a hologram recording medium as strip-shaped element holograms, so that the original plate is manufactured. A hologram recording medium is closely attached to the original plate, irradiated with laser light, and the hologram is copied.

In this hologram, for example, image information obtained by sequentially capturing images from different viewpoints in a horizontal direction is sequentially recorded in the horizontal direction as strip-shaped element holograms. When an observer views the hologram with both eyes, the two-dimensional images viewed by the left and right eyes are slightly different to each other. In this way, the observer feels a parallax, so that a three-dimensional image is reproduced.

As described above, when the strip-shaped element holograms are sequentially recorded, an HPO (Horizontal Parallax Only) holographic stereogram having parallax only in the horizontal direction is produced. The HPO type takes a short time to print, and can realize high image quality recording. Furthermore, vertical parallax can be included in a recording method. A hologram having a parallax in both the horizontal direction and the vertical direction is referred to as an FP (Full Parallax) type hologram.

The Lippmann type hologram is more difficult to forge than the embossed type hologram, and suitable for a use to determine authenticity of a credit card, an identification card, and the like. Further, when an additional information such as a serial number and identification information (ID) can be recorded, forgery becomes more difficult. Since it is not efficient to produce holograms one by one using a printer, there is a method in which many holograms are copied by a contact copy.

The inventor of the present invention proposes a hologram replication apparatus and a hologram replication method which can record additional information at the same time as replication when the hologram is replicated. The hologram replicated in this method can reproduce holographically-recorded text information and barcode information in accordance with a viewing angle. The recorded data is not only recognized by human eyes, but also highly desired to be photoelectrically converted by an image capturing camera and read by a machine. For example, in a so-called verification process which determines whether or not the additional information recorded on the hologram recording material in a manufacturing process is recorded without error, it is desired that the hologram is read by a machine in production equipment.

By the characteristics of hologram, a parallel light or a point light source is desired to irradiate a certain portion of the hologram. When a plurality of light sources irradiate the portion, different images are reproduced by the plurality of light sources, and a plurality of overlapped images in which the different images are overlapped are reproduced, so that the image blurs. In a similar way, when the portion is irradiated by an area light source, the image blurs.

On the other hand, when the hologram has to be obliquely irradiated from a point near the surface, it is difficult for the parallel light or the point light source to irradiate the entire area evenly. Actually, an LED (Light Emitting Diode), a xenon lamp, a halogen lamp, and the like are difficult to be an ideal point light source, and hence even when a light axis is aligned to a predetermined axis in a lens system, a light amount difference occurs between an area near the light source and an area far from the light source.

When a plurality of light sources such as LEDs are arranged closely, light amount unevenness can be improved. However, a portion near the center of a plurality of light sources is irradiated from two light sources at the same time, so that overlapped images are reproduced. It is difficult to read correctly from the overlapped images, and error or false recognition occurs.

Japanese Unexamined Patent Application Publication No. 11-258970 describes a method to reduce influence of crosstalk caused by a reproduction reference light that irradiates adjacent element holograms when reading an element hologram. The method described in Japanese Unexamined Patent Application Publication No. 11-258970 is to reduce crosstalk by limiting a diameter of light flux of the reproduction reference light by a diaphragm.

### SUMMARY OF THE INVENTION

The method described in Japanese Unexamined Patent Application Publication No. 11-258970 does not solve the problem of the overlapped images when a plurality of LEDs are used as a light source. Furthermore, as described in Japanese Unexamined Patent Application Publication No. 11-258970, adding a diaphragm causes a problem that the number of optical parts increases.

Therefore, it is desirable to provide a hologram reproducing and imaging apparatus and a hologram reproducing and imaging method which can clearly capture a hologram reproduction image, for example, a reproduction image of additional information recorded on a hologram recording material without crosstalk.

According to an embodiment of the present invention, there is provided a hologram reproducing and imaging apparatus including

a reference light source configured to be arranged near a hologram recording material on which a hologram is recorded and has an arrangement of a plurality of light sources,

a reference light source drive section configured to drive the plurality of light sources in a time-division manner,

an imaging sensor configured to capture an image of a reproduction area irradiated with reference light from the reference light source and photoelectrically convert the image, and

an image processing section configured to process an imaging signal from the imaging sensor,

wherein partial captured images are obtained by enabling the imaging signal of the area irradiated when the plurality of light sources are turned on, and the partial captured images are combined to be a reproduction image by the image processing section.

Also, according to an embodiment of the present invention, there is provided a hologram reproducing and imaging method including the steps of

irradiating a hologram recording material with a reference light by driving a reference light source which is arranged near the hologram recording material on which a hologram is recorded and has an arrangement of a plurality of light sources in a time-division manner,

capturing an image of a reproduction area irradiated with the reference light from the reference light source and photoelectrically converting the image by an imaging sensor,

obtaining partial captured images by enabling an imaging signal of the area irradiated when the plurality of light sources are turned on, and

combining the partial captured images to form a reproduction image.

According to an embodiment of the present invention, a clear reproduction image without crosstalk can be obtained by a small and simple optical system and a low cost device.

### BRIEF DESCRIPTION OF THE DRAWINGS

FIG. 1 is a schematic diagram illustrating a configuration of an example of a replication apparatus to which an embodiment of the present invention can be applied;

FIG. 2 is a schematic diagram used for general explanation of view angle;

FIG. 3 is a schematic diagram used for explanation of view angle in the replication apparatus to which an embodiment of the present invention can be applied;

FIG. 4 is a schematic diagram used for explanation of an example in which an embodiment of the present invention is applied to a verification apparatus of the replication apparatus;

FIG. 5 is a schematic diagram used for explanation of another example in which an embodiment of the present invention is applied to the verification apparatus of the replication apparatus;

FIG. 6 is a schematic diagram illustrating a configuration of another example of the replication apparatus to which an embodiment of the present invention can be applied;

FIG. 7 is a schematic diagram used for explanation of a general driving method of a reference light source;

FIG. 8 is a schematic diagram used for explanation of time-division driving of the reference light source according to an embodiment of the present invention;

FIG. 9 is a schematic diagram used for explanation of time-division driving of the reference light source according to an embodiment of the present invention;

FIG. 10 is a block diagram of an embodiment of the present invention;

FIG. 11 is a timing chart used for explanation of a driving method of the reference light source according to an embodiment of the present invention;

FIG. 12 is a schematic diagram illustrating a configuration of a first example of an imaging optical system according to a first embodiment of the present invention;

FIG. 13 is a schematic diagram illustrating a configuration of a second example of the imaging optical system according to the first embodiment of the present invention;

FIG. 14 is a schematic diagram illustrating a configuration of a first example of an imaging optical system according to a second embodiment of the present invention;

FIG. 15 is a schematic diagram illustrating a configuration of a second example of the imaging optical system according to the second embodiment of the present invention;

FIG. 16 is a schematic diagram illustrating a configuration of a third example of the imaging optical system according to the second embodiment of the present invention;

FIG. 17 is a schematic diagram illustrating a configuration of a fourth example of the imaging optical system according to the second embodiment of the present invention; and

FIG. 18 is a schematic diagram illustrating a configuration of a fifth example of the imaging optical system according to the second embodiment of the present invention.

### DESCRIPTION OF THE PREFERRED EMBODIMENTS

Hereinafter, preferred embodiments (hereinafter referred to as embodiments) to implement the present invention will be described. The embodiments will be described in the following order.
<1. First embodiment>
<2. Second embodiment>
<3. Modified embodiment>

Although the embodiments described below are specific examples suitable to the present invention, and technically preferable various limitations are given, the scope of the invention is not limited to the embodiments unless a statement that limits the present invention is provided in the following description.

### 1. First Embodiment

### Configuration of Replication Apparatus

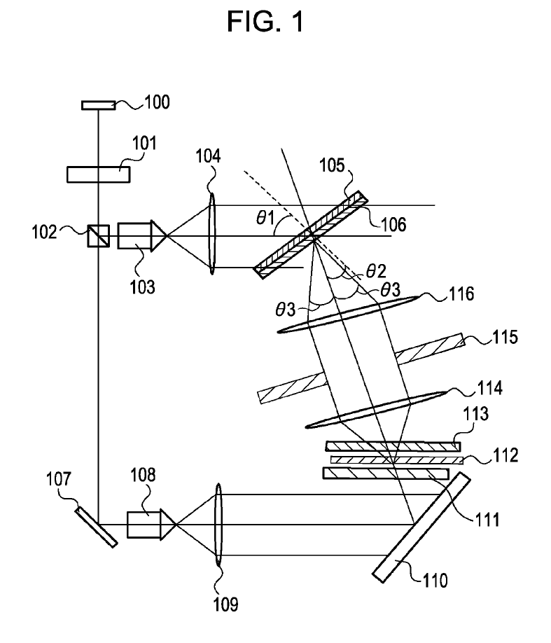

A replication apparatus to which an embodiment of the present invention can be applied will be described with reference to FIG. 1. The replication apparatus replicates a hologram from a hologram original plate to a hologram recording medium, and at the same time, records additional information such as a serial number and identification information.

Laser light from a laser light source 100 enters a polarizing beam splitter 102 through a half-wavelength plate 101. The half-wavelength plate 101 rotates a polarization plane of the laser light by 90°. The laser light (S-polarized light) is reflected by the polarizing beam splitter 102, and the laser light is spread by a spatial filter 103. The laser light (in other words, reference light) from the spatial filter 103 enters a collimation lens 104. The laser light which is converted into parallel light by the collimation lens 104 is irradiated to a hologram recording medium 105 having a layer of photosensitive material and a hologram original plate 106.

The hologram original plate 106 is, for example, a holographic stereogram having a parallax in the horizontal direction when observed. The hologram original plate 106 may be a holographic stereogram having a parallax in both the horizontal direction and the vertical direction. Further, the hologram original plate 106 may be a real-scene hologram which is produced by irradiating an object with laser light. Generally, a hologram for reproducing a three dimensional image can be formed by combining two original images, which are two dimensional images of an object seen from different viewpoints. For example, the holographic stereogram is produced by sequentially recording many images obtained by sequentially capturing images of an object from different viewpoints as original images, on a hologram recording medium in a form of strip-shaped element holograms.

The hologram recording medium 105 and the hologram original plate 106 are directly attached to each other, or closely attached to each other via a refractive index adjustment liquid (referred to as an index matching liquid). On the hologram recording medium 105, interference fringes formed by light diffracted by the hologram original plate 106 and the reference light, and interference fringes formed by additional information light and the reference light are recorded.

The laser light (P-polarized light) passing through the polarizing beam splitter 102 is reflected by the mirror 107, and enters a spatial filter 108. The laser light spread by the spatial filter 108 is converted into parallel light by a collimation lens 109, and hits the mirror 110.

The laser light reflected by the mirror 110 enters a liquid crystal panel 112 acting as a spatial light modulation element through a diffuser panel 111. The diffuser panel 111 widens a view angle of a replicated holographic stereogram by diffusing the laser light from the mirror 110 in at least either one of the width direction and the longitudinal direction of an element hologram. The laser light diffused by the diffuser panel 111 is narrowed down by a diaphragm (mask) 115, and the view angle is widened only when observed from the front.

Although not illustrated in FIG. 1, a liquid crystal drive section, for example, a microcomputer is connected to the liquid crystal panel 112. An image of the additional information is displayed on the liquid crystal panel 112 by the liquid crystal drive section. As the additional information, identification information such as a number (serial number) unique to each hologram is used. A polarizing plate 113 is provided on an emitting surface of the liquid crystal panel 112. The polarization plane is rotated by the liquid crystal panel 112, and P-wave is converted into S-wave.

The additional information light generated by the liquid crystal panel 112 and passed through the polarizing plate 113 enters the hologram original plate 106 via an image forming optical system constituted by a projection lens 114, the diaphragm 115, and a projection lens 116. On the hologram recording medium 105, interference fringes formed by light in which light diffracted by the hologram original plate 106 and the additional information light passed through the hologram original plate 106 are overlapped and incident laser light are recorded. As a result, the additional information can be recorded in a hologram area in the hologram original plate 106.

### [About View Angle]

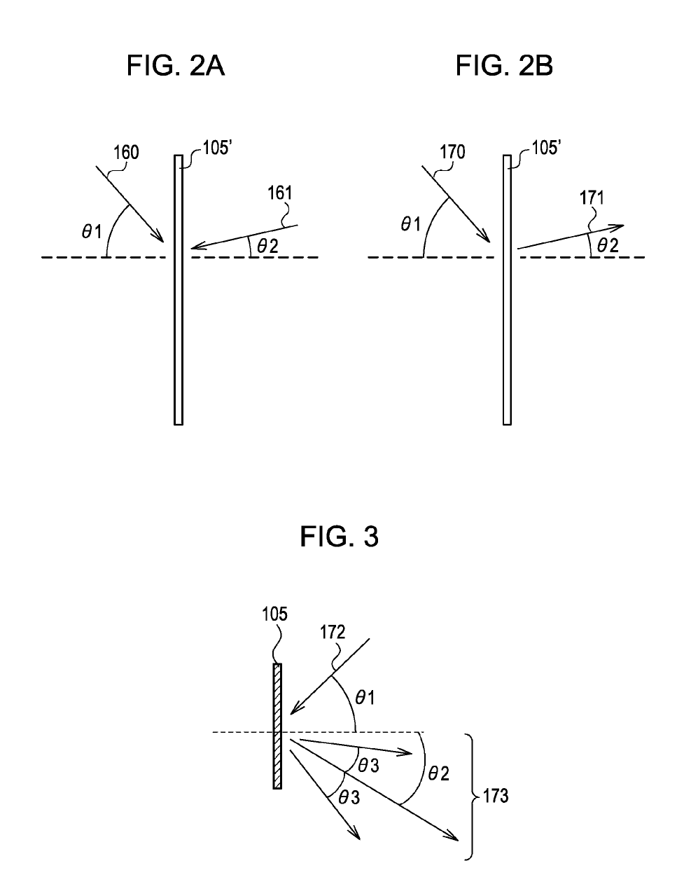

A general relationship between recording on the hologram recording medium 105 and a view angle when reproducing the recorded hologram recording medium 105 will be described with reference to FIG. 2. As illustrated in FIG. 2A, when recording, the reference light 160 enters the hologram recording medium 105′ at an incident angle of θ1, and the object light 161 enters the hologram recording medium 105′ from the opposite side of the hologram recording medium 105′ at an incident angle of θ2. Interference fringes formed by the object light 161 and the reference light 160 are recorded on the hologram recording medium 105′.

As illustrated in FIG. 2B, when irradiating the illumination light 170 to the hologram recording medium 105′ on which the interference fringes are recorded in the above way at an incident angle of θ1, the object light (reproduction light) 171 is emitted at an output angle of θ2 by the hologram recording medium 105′. As a result, the object light can be seen from a viewpoint in an object light 171 outgoing direction.

In the replication apparatus, as illustrated in FIG. 1, the reference light enters the hologram recording medium 105 at an incident angle of θ1, the additional information light enters the hologram recording medium 105 at an incident angle of θ2, and the additional information light has a spreading angle of ±θ3. During reproduction, as illustrated in FIG. 3, the reference light 172 enters the replicated hologram medium 105 at an incident angle of θ1. The additional information light 173 reproduced by the hologram recording medium 105 has a spreading angle of ±θ3, the center of which is the output angle of θ2. In other words, the additional information can be seen only when the viewpoint is in an angle range of ±θ3, the center of which is the output angle of θ2.

The center of the angle from which the additional information can be seen when the replicated hologram recording medium 105 is reproduced can be set by the incident angle θ2 at which the optical axis of the additional information light enters the hologram recording medium 105. Further, the range of the angle from which the additional information can be seen during reproduction can be set by the image forming optical system constituted by the projection lenses 114, 116, and the diaphragm 115.

Therefore, the hologram recording medium 105 has characteristics described below, and the hologram image and the additional information image can be observed independently from each other by moving the viewpoint. The viewpoint can be moved by moving eyes or moving the hologram recording medium.

When illuminating from a predetermined angle, a hologram image which has at least a continuous parallax in the horizontal direction when the viewpoint is moved in the left-right direction of the normal line, and a view angle controlled in the up-down direction is reproduced. In this case, the view angle in the up-down direction may not be controlled.

A refractive index modulation is recorded in a single layer of material so that another image (additional information image) which is different from and separated from the hologram image is reproduced when the viewpoint is relatively moved in at least one of the up-down direction and the left-right direction from the normal line of the hologram recording medium.

The hologram image is a hologram or a holographic stereogram on which an image is recorded. As a hologram which is reproduced from an angle different from at least one of the up-down direction and the left-right direction, the hologram is a two-dimensional image positioned in an approximately constant plane in the depth direction. The two-dimensional image positioned in an approximately constant plane in the depth direction is the additional information image including identification information.

The replication apparatus described above can record an additional information image (such as a serial number and machine-readable barcode information) in a hologram area. Further, the replication apparatus can prevent the additional information from disturbing the observation of the original hologram image because the replication apparatus can define a range of the viewpoint from which the additional information image can be seen.

### [Verification Apparatus]

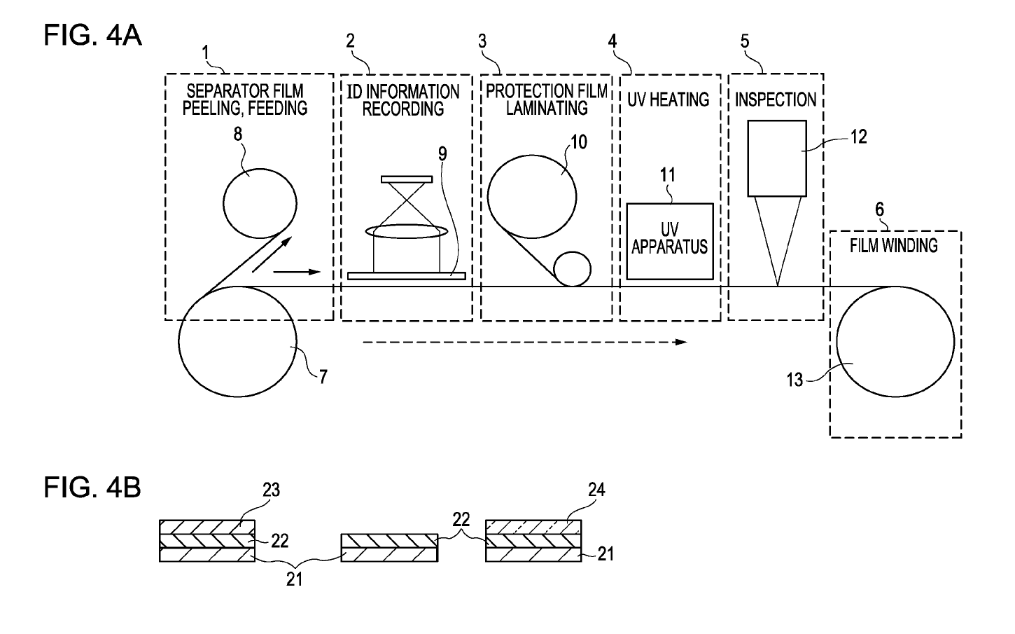

In a hologram producing process using the replication apparatus, a so-called inspection (verification) process which checks whether or not the additional information recorded on the hologram recording material is recorded without error is provided. As illustrated in FIG. 4A, a separator film peeling/feeding process 1, an ID information recording process 2, a protection film laminating process 3, a UV (ultraviolet rays) heating process 4, an inspection process 5, and a film winding process 6 are sequentially performed.

As illustrated in FIG. 4B, a recording film in which a hologram recording material 22 is coated on a base film 21 and further a separator 23 is coated on the hologram recording material 22 is wound around a roller 7. In the separator film peeling/feeding process 1, the separator 23 is reeled in by a separator reel roller 8. The separator 23 is peeled, and the hologram recording material 22 (corresponding to the hologram recording medium 105 in FIG. 1) coated on a base film 21 is transferred to the ID information recording process 2.

In the ID information recording process 2, a hologram image is recorded on the hologram recording material 22 by using a hologram original plate 9 (corresponding to the hologram original plate 106 in FIG. 1), and ID information is recorded. In the ID information recording process 2, the recorded hologram recording material is transferred to the protection film laminating process 3.

In the protection film laminating process 3, a transparent protection film 24 fed from a roller 10 is laminated on the hologram recording material 22. The hologram recording material 22 on which the protection film 24 is laminated is transferred to the UV heating process 4. In the UV heating process 4, a UV apparatus 11 irradiates ultraviolet rays to the hologram recording material 22 though the protection film 24. The UV heating process 4 has a function as a fixing section which fixes a hologram record. In the UV heating process 4, the protection film 24 may be attached to the hologram recording material 22.

A laminated film of the base film 21, the hologram recording material 22, and the protection film 24 transferred from the UV heating process 4 is inspected in the inspection process 5. In other words, whether or not expected additional information is successfully recorded is inspected by an inspection apparatus 12. In the inspection process 5, whether or not the hologram image is successfully replicated may be inspected in addition to the additional information. The inspected film is transferred to the film winding process 6, and wounded by a roller 13.

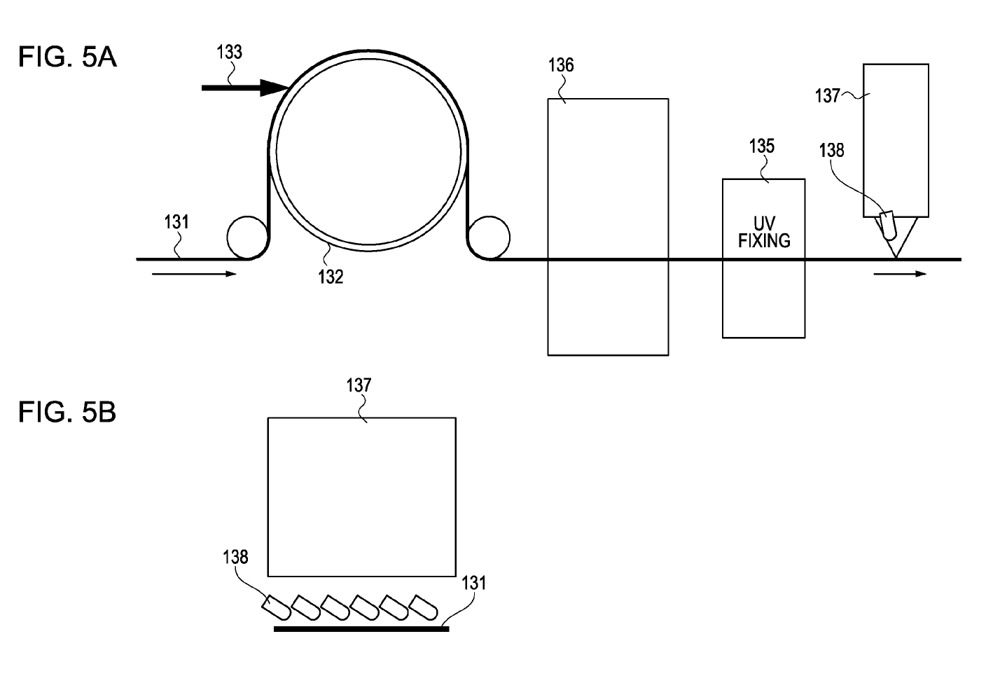

Another form in which an inspection process is added to the producing process will be described with reference to FIG. 5. In the producing process illustrated in FIG. 5, the additional information may be recorded by using a laser light different from the laser light to replicate a hologram by contact print.

As illustrated in FIG. 5A, the contact print is performed, and the additional information is recorded before the hologram is fixed by a UV fixing section 135. A hologram recording film 131 fed from a roller not illustrated in FIG. 5 is wound around a roller. A hologram original plate 132 is attached to the circumferential surface of the roller. The hologram original plate 132 is, for example, horizontal direction continuous parallax images. A replication laser light 133 is irradiated while the hologram original plate 132 and the hologram recording film 131 are closely attached to each other, and the hologram on the hologram original plate 132 is replicated on the hologram recording film 131.

The replication is performed by transferring the hologram recording film 131. After the replication, the hologram recording film 131 is transferred toward the UV fixing section 135. Before the UV fixing section 135, an additional information recording section 136 is provided. The hologram recording film 131 on which the hologram has been fixed by the UV fixing section 135 is transferred to an inspection apparatus 137, and whether or not the additional information is appropriately recorded is inspected.

In the inspection apparatus 137, a reference light source 138 for generating a reproduction reference light to reproduce the additional information recorded on the hologram recording film 131 is provided. As illustrated in FIG. 5B, the reference light source 138 has an arrangement in which a plurality of point light sources such as LEDs are aligned in a line in a direction perpendicular to the transfer direction of the hologram recording film 131. The reproduction reference light generated from the reference light source 138 has the same wavelength (a single wavelength, white light wavelength, and the like) as that of a recording reference light in the additional information recording section 136 so that the additional information can be reproduced, and enters the hologram recording film 131 at the same incident angle as that of the recording reference light. Compared with angular multiplexing in a holographic storage technique, the uniformity of the wavelength and the incident angel of the reference light to reproduce the additional information is not so strict.

When the reproduction reference light is irradiated, the additional information recorded on the hologram recording film 131 is reproduced. As described below, the reproduced additional information is captured and photoelectrically converted by an imaging sensor. By analyzing a captured image captured by the imaging sensor, whether or not the additional information is successfully recorded is inspected.

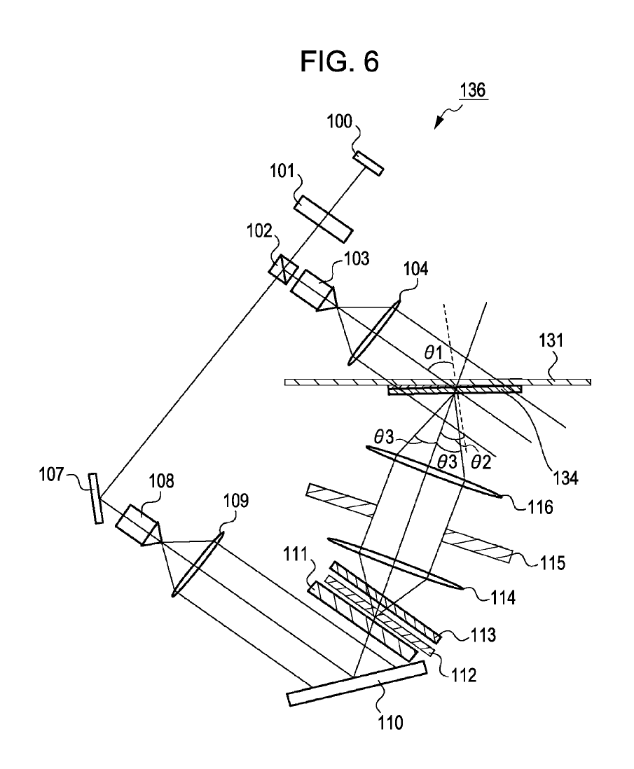

FIG. 6 illustrates an example of the additional information recording section 136. The reference light generated by the laser light source 100, the half-wavelength plate 101, the polarizing beam splitter 102, the spatial filter 103, and the collimation lens 104 enters the hologram recording film 131. The hologram recording film 131 is transferred in the direction perpendicular to the page. The hologram recording film 131 is a film in which a photosensitive material is coated on a transparent base film. The laser light source 100 used in the additional information recording section 136 may be a pulse laser, and in this case, it is possible to perform continuous processing without stopping the transfer of the hologram recording film 131 if sufficient energy for recording is provided.

The laser light which is reflected by the mirror 107, passes through the spatial filter 108 and the collimation lens 109, and reflected by the mirror 110 becomes a branched laser light. The branched laser light enters the liquid crystal panel 112 through the diffuser panel 111 in the same way as in the replication apparatus illustrated in FIG. 1. The additional information image in the liquid crystal panel 112 is formed on the hologram recording film 131 via the polarizing plate 113, the image forming optical system (the projection lenses 114, 115, and the diaphragm 115), and a louver 134. By providing the louver 134, it is possible to prevent unnecessary light such as reflection light from entering the hologram original plate 106. A transparent plate may be used instead of the louver 134.

### [Control of Reference Light Source in the Inspection Apparatus]

An inspection apparatus according to an embodiment of the present invention which can be applied to the inspection apparatus 137 in FIG. 5 will be described. However, the inspection apparatus according to an embodiment of the present invention can be applied to the inspection process 5 in FIG. 4. A problem which occurs when reproducing the additional information during reproduction will be described.

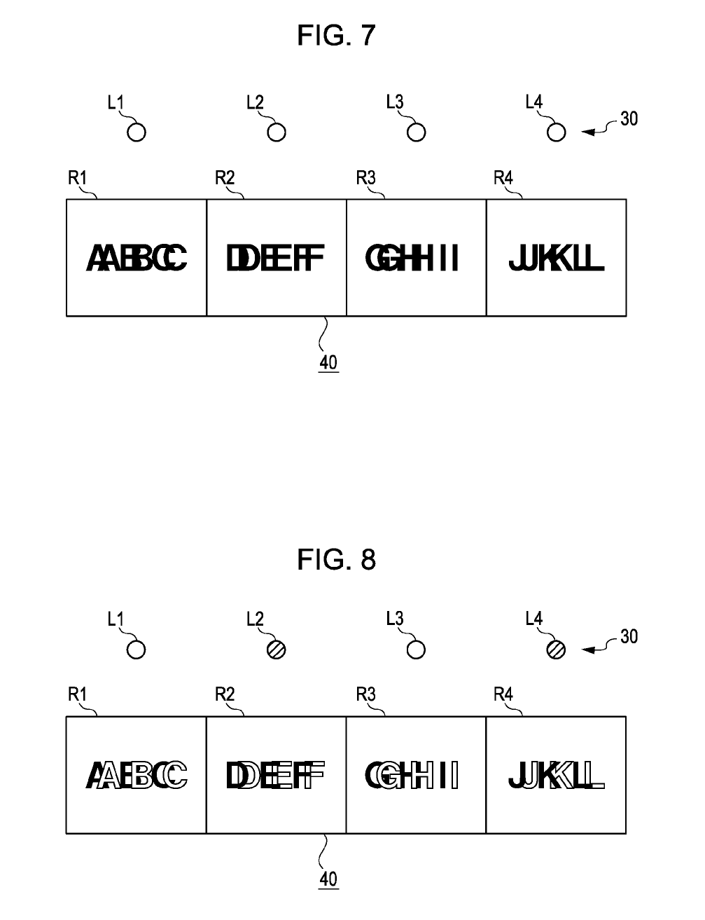

As illustrated in FIG. 7, for example, the reference light source 30 is constituted by four LEDs LED L1, LED L2, LED L3, and LED L4 (hereinafter simply referred to as L1, L2, L3, and L4). The hologram recording material is irradiated by the reference light source 30. The reference light has approximately the same wavelength as that of the reference light used when recording the additional information. A reproduction area 40 is set in accordance with an area which a two-dimensionally readable imaging sensor (CCD (Charge Coupled Device), CMOS (Complementary Metal Oxide Semiconductor), or the like) can reproduce at the same time. The reproduction area 40 is both an illumination area and an imaging area. In the reproduction area 40, a divided area R1, a divided area R2, a divided area R3, and a divided area R4 (hereinafter simply referred to as R1, R2, R3, and R4) are irradiated by the L1, L2, L3, and L4 respectively.

Additional information, for example, characters “ABC” are reproduced from the R1, additional information, for example, characters “DEF” are reproduced from the R2, additional information, for example, characters “GHI” are reproduced from the R3, and additional information, for example, characters “JKL” are reproduced from the R2. When irradiating from the L1 to L4 of the reference light source 30 at the same time, an image is reproduced by the reference lights from a plurality of adjacent LEDs, doubly overlapped images and triply overlapped images are generated, and blur of the hologram reproduction image occurs.

To solve this problem, as illustrated in FIG. 8, every other LED is turned on and off alternately. In other words, at a certain timing, L1 and L3 are turned on at the same time and L2 and L4 are turned off, and at the next timing, L1 and L3 are turned off and L2 and L4 are turned on at the same time. In FIG. 8, an image reproduced by the irradiation from L1 and L3 is represented by white characters, and an image reproduced by the irradiation from L2 and L4 is represented by black characters.

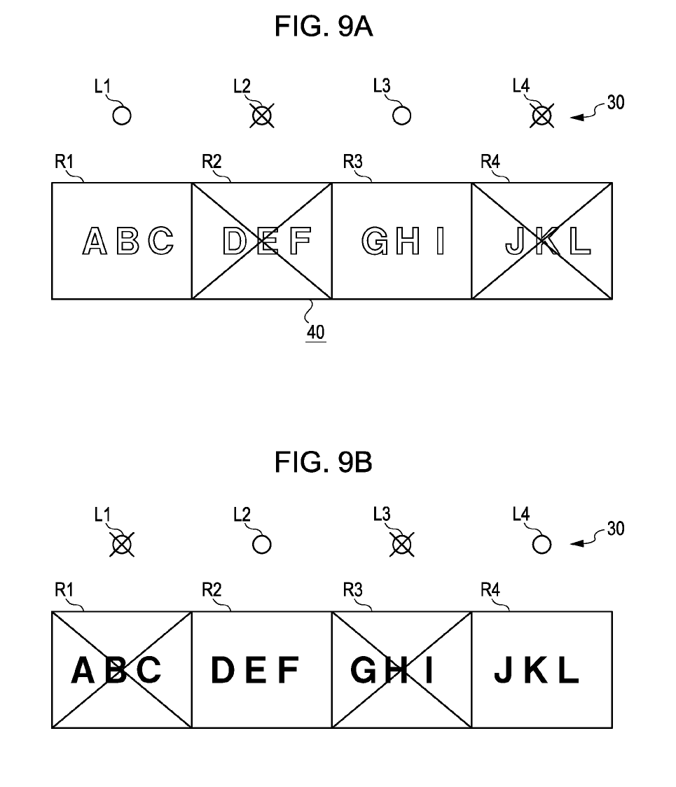

At a certain timing, as illustrated in FIG. 9A, L1 and L3 are turned on at the same time and L2 and L4 are turned off. Only the reference lights from L1 and L3 are irradiated to R1 and R3 respectively, and only the reference lights from L1 and L3 are irradiated to R2 and R4 respectively.

At the next timing, as illustrated in FIG. 9B, the L1 and L3 are turned off and the L2 and L4 are turned on at the same time. Only the reference lights from L2 and L4 are irradiated to R1 and R3 respectively, and only the reference lights from L2 and L4 are irradiated to R2 and R4 respectively.

Further, areas from which the imaging sensor captures images are switched in synchronization with switching of the LEDs. Specifically, in FIG. 9A, R2 and R4 are not captured, and in FIG. 9B, R2 and R4 are not captured. Instead of controlling the imaging sensor itself, an output signal from the imaging sensor may be partially disabled. Each area is irradiated by a single reference light, so that it is possible to prevent overlapped images from occurring.

When performing the hologram reproduction and capture in this way, the hologram reproduction images of R1 and R3, and the hologram reproduction images of R2 and R4 can be obtained by two times of capturing operations. Since the imaging sensor, the light sources, and the hologram are fixed, an area occupied by the hologram reproduction image in an image is also fixed. Therefore, when cutting out a necessary image from each image and generating a composite image, an entire image having high sharpness can be obtained. As another method, if sensitivity of the imaging sensor is sufficient for the brightness of the hologram reproduction image, it is possible to capture a desired hologram reproduction image using a single captured image by completing switching of the LEDs in one time image capturing operation.

Although the above example is described using four light sources, the example may be constituted by using more than four (tens of, hundreds of) light sources. In addition, the number of light sources which emit light at the same time can be arbitrary selected unless there is crosstalk. When the light sources are two dimensionally arranged and the imaging area is switched as the light sources are switched, the relative positions of the imaging sensor, the hologram, and light sources have not necessarily to be moved.

### [Signal Processing Circuit of the Inspection Apparatus]

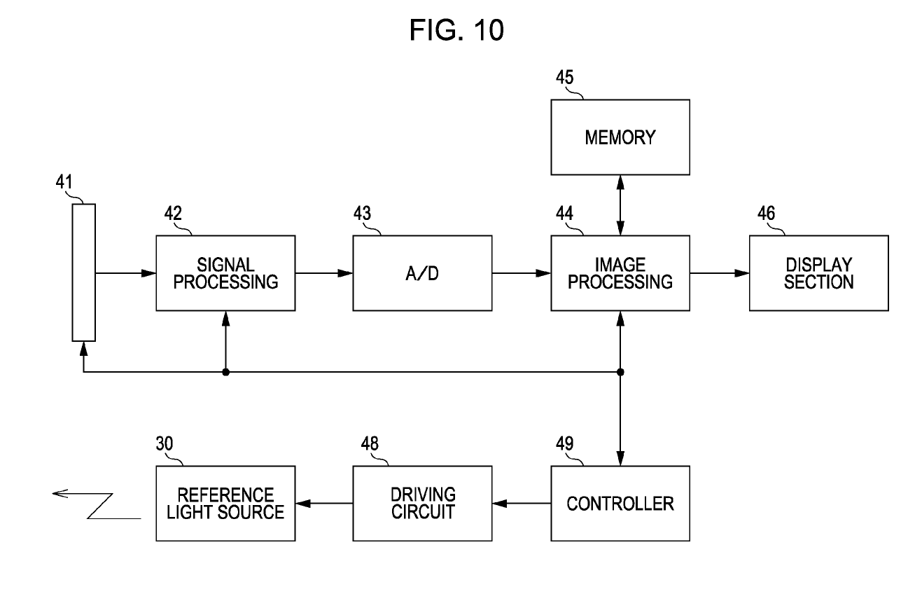

As illustrated in FIG. 10, a reproduction image of the additional information is read by an imaging sensor 41, and photoelectrically converted. Processing such as gain correction, noise elimination, and the like are performed on an output signal from the imaging sensor 41 by a signal processing circuit 42. An imaging signal from the signal processing circuit 42 is converted into a digital imaging signal by an A/D converter 43.

The digital imaging signal is supplied to an image processing circuit 44. A memory 45 is provided in relation to the image processing circuit 44. The image processing circuit 44 processes the digital imaging signal accumulated in the memory 45, and combines partially-read images to obtain a reproduction image of the additional information. Further, the image processing circuit 44 determines whether or not the reproduction image of a predetermined additional information is correctly reproduced. An output signal from the image processing circuit 44 is supplied to a display section 46. The display section 46 displays the reproduction image, the determination result (OK/NG), and the like.

As described above, the reference light source 30 in which a plurality of LEDs are aligned in a line is driven by a driving signal from a driving circuit 48. The driving signal from a controller 49 is supplied to the driving circuit 48. The controller 49 generates a control signal to control the imaging sensor 41, the signal processing circuit 42, the image processing circuit 44, and the like which constitute the inspection apparatus. The switching of the reference light source 30 and the image capturing operation synchronized with the switching are performed by the controller 49.

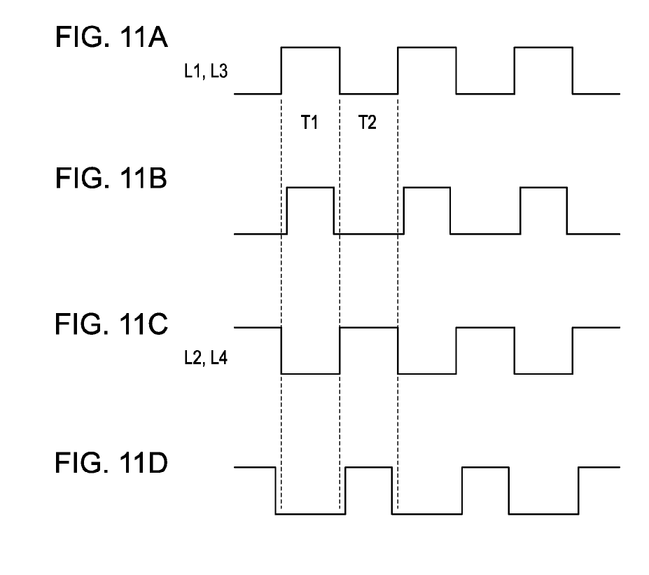

The timing chart in FIG. 11 illustrates timing of driving of the reference light source 30 and exposure of the imaging sensor 41. As illustrated in FIG. 11A, in the period T1 in which the pulse signal is at high level, L1 and L3 are turned on. As illustrated in FIG. 11C, in the period T2 in which the pulse signal is at high level, L2 and L4 are turned on.

In FIG. 11B, in the high level period T1, the additional information reproduced by L1 and L3 is captured by the imaging sensor 41, and imaging signals of partial images of R1 to R4 are obtained. The imaging signal is accumulated in the memory 45. In FIG. 11D, in the high level period T2, the additional information reproduced by L2 and L4 is captured by the imaging sensor 41, and imaging signals of partial images of R1 to R4 are obtained. The imaging signal is accumulated in the memory 45.

The image processing circuit 44 reproduces the image of the additional information by combining the images accumulated in the memory 45. The reproduced image is outputted to the display section 46 by the image processing circuit 44, and the reproduction image of the additional information is displayed on the display section 46. Further, whether or not the additional information is correctly reproduced is determined from the reproduction image by the image processing circuit 44. The determination result is displayed on the display section 46.

Further, the image processing circuit 44 may correct distortion generated by irradiating diffusion light instead of parallel light. In other words, image correction processing is performed on a captured image on the basis of existing distortion parameter, and processing which smoothly connects images on the boundaries of the divided areas is performed.

### [Optical System in the Inspection Apparatus]

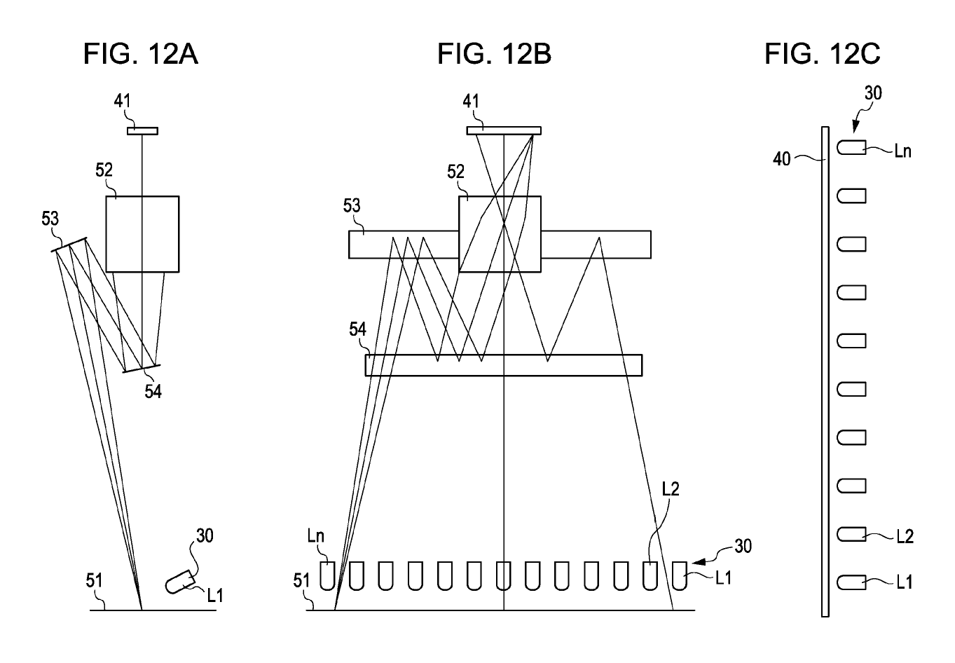

As illustrated in FIG. 12, the reference lights from the reference light source 30 constituted by n LEDs (L1 to Ln) adjacently aligned in a line are irradiated to a hologram surface 51 of the hologram recording material, and an image of the linear reproduction area 40 is captured by the imaging sensor 41. An incident angle of the light from the LED to the hologram surface 51 has a predetermined value to reproduce the additional information. FIG. 12A is a side view, FIG. 12B is a front view, and FIG. 12C is a plan view. With reference to the above described producing process in FIG. 5, the hologram surface 51 is transferred in the direction perpendicular to the page of FIG. 12A. In other words, in the configuration of FIG. 12, the reference light enters so that the reference light has a predetermined incident angle to the direction perpendicular to the transfer direction. The predetermined incident angle means an angle which can reproduce the hologram of the additional information.

Ideally, the imaging optical system should be constructed by a so-called telecentric optical system so that the reproduction area 40 can be read at the same angle over the entire width thereof. However, in such a telecentric optical system, a large lens and a large optical system are used, and hence, a non-telecentric lens 52 is used.

The light from the reproduction area 40 is sequentially reflected by a mirror 53 and a mirror 54, and enters the imaging sensor 41. The reason to use the mirror 53 and the mirror 54 is to reduce the size (height) of the optical system.

As described above, the adjacent LEDs are driven not to emit light at the same time. The imaging area is selectively changed in synchronization with the switching timing at this time, and finally information of the entire area 40 that should be read is obtained. In order to irradiate light from only one LED to the area to be captured in the reproduction area 40, not only the adjacent LEDs emit light alternately, but also one LED out of three LEDs, or one LED out of four LEDs may emit light. When using an LED with a shell-type lens as the LED, image capturing can be performed with small distortion even when a collimate optical system is not used. More actively, the reference light may be irradiated as parallel light by using a micro-lens array. Since the small distortion generated here is a given distortion, in a boundary portion of the image capturing area, distortion correction can be performed on the captured image by image processing. Also, variation of brightness of the hologram reproduction image reproduced by each LED can be corrected by the image processing after image capturing. Further, by changing the incident angle of the reference light from the LED depending on the position, the reading angle may be controlled not to be changed.

If a line sensor is used as the imaging sensor 41, when the hologram in the reproduction area 40 is captured, the hologram recording material is transferred by one step, and the hologram in the adjacent reproduction area 40 is captured. A plurality of linear images obtained by repeating the sequential transfer operations are combined to be a single reproduction image by the image processing. By setting a linear reproduction area 40, it is possible to prevent the incident angle of the reference light to the hologram surface 51 from being different from a predetermined value in the short side direction of the reproduction area 40. However, it is possible to increase the width of the reproduction area 40 in an acceptable range to form a strip-shaped area.

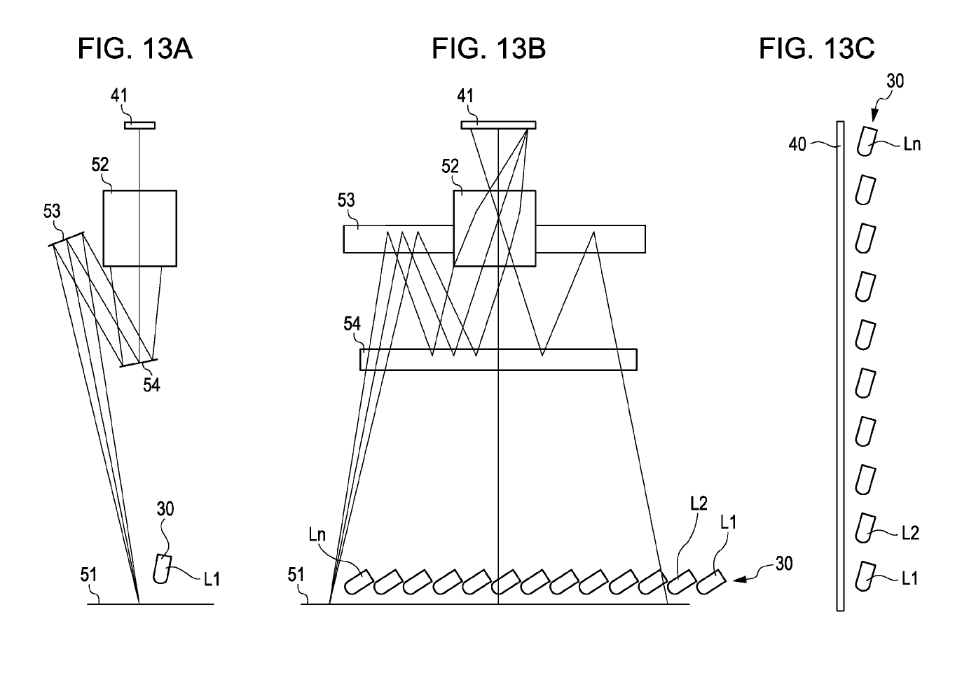

FIG. 13 is another example of the imaging optical system. FIG. 13A is a side view, FIG. 13B is a front view, and FIG. 13C is a plan view. In FIG. 13C, the reproduction area 40 is illustrated. With reference to the above described producing process in FIG. 5, the hologram surface 51 is transferred in the direction perpendicular to the page of FIG. 13A. In other words, in the configuration of FIG. 13, the reference light enters so that the reference light has a predetermined incident angle to the direction parallel to the transfer direction. In the same way as the optical system illustrated in FIG. 12, an optical system constituted by the lens 52, the mirror 53, and the mirror 54 which are non-telecentric is arranged between the imaging sensor 41 and the hologram surface 51.

### 2. Second Embodiment

### Imaging Optical System

The second embodiment of the present invention will be described. As a method for reading information recorded in a hologram, when capturing image by scanning the hologram, it is easy to capture a high resolution image because the image is captured in the same condition at least in the scanning direction. The reference light irradiating the hologram obliquely enters the hologram, and as the reference light, near parallel light should be uniformly irradiated from a position in an optical path reaching the hologram at a predetermined angle. Specifically, the reference light has to enter from the direction in which reference light entered when the hologram was produced.

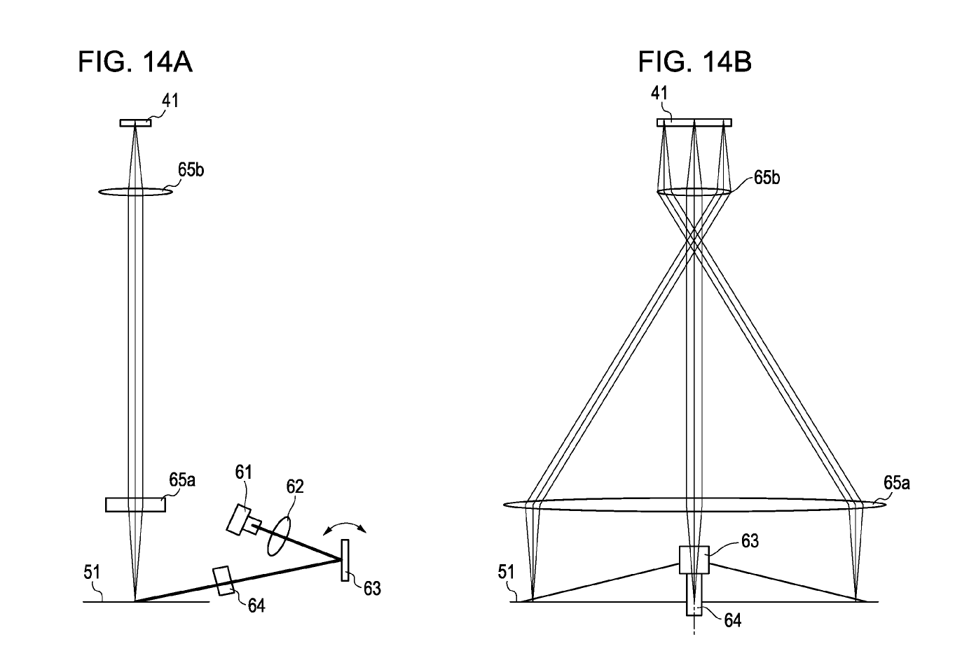

FIG. 14 illustrates a first example of the imaging optical system. FIG. 14A is a side view and FIG. 13B is a front view. The laser light from a laser light source 61 is converted into parallel light by a collimator lens 62, and hits a galvano mirror 63. Instead of the galvano mirror 63, an optical scanning actuator such as a resonant scanner or a polygon mirror may be used. The galvano mirror 63 is rotated by a driving mechanism not illustrated in FIG. 14 so that the mirror surface is tilted.

The laser light reflected by the galvano mirror 63 enters the hologram surface 51 through a telecentric fθ lens 64 at a predetermined incident angle. The telecentric fθ lens 64 has a function to scan the laser light scanned at a constant angular velocity by the galvano mirror 63 on the image forming surface (hologram surface 51) at a constant speed.

The hologram surface 51 is transferred in the direction perpendicular to the page of FIG. 14A. In other words, in the configuration of FIG. 14, the reference light enters so that the reference light has a predetermined incident angle to the direction perpendicular to the transfer direction. The predetermined incident angle means an angle which can reproduce the hologram of the additional information.

Telecentric fθ lenses 65a and 65b are arranged between the hologram surface 51 and the imaging sensor 41. The hologram reproduction image at the position where the laser light scans is read perpendicularly to the hologram surface 51 by the telecentric fθ lenses 65a and 65b.

The exposure time of a single line scan of the imaging sensor 41 is set to at least the one-way scanning time, and the image capturing is performed to obtain information of the entire width. When the line scan time and the exposure time are not so different from each other, for example, when the exposure time is 1.5 times the line scan time, one portion may be scanned two times and another portion may be scanned only once, so that a partial density difference Occurs. In order to prevent this problem from occurring, the image capturing is performed by using an exposure time near one cycle of the line or an integral multiple of the cycle. Furthermore, by synchronizing the timing of the scanning and the image capturing, uniformity of the image can be realized.

In the configuration of FIG. 14, the reference light is fθ-converted by the lens 64 so that the scanning speed of the reference light of the hologram becomes approximately the same speed on the hologram surface. Instead of the above, for example, by performing a speed control of the scan drive actuator such as the galvano mirror 63, the scanning speed can be controlled to be the same speed as much as possible. When the speed varies, an amount of light irradiated to the hologram varies. To prevent the speed variation from negatively affecting the uniformity of brightness during the image capturing, the scanning speed is set to the same speed. Furthermore, when the differences of an amount of light between scan lines are obtained in advance by calibration or the like, by obtaining a correction coefficient for each scan line, brightness unevenness of the hologram reproduction image can be corrected by image processing.

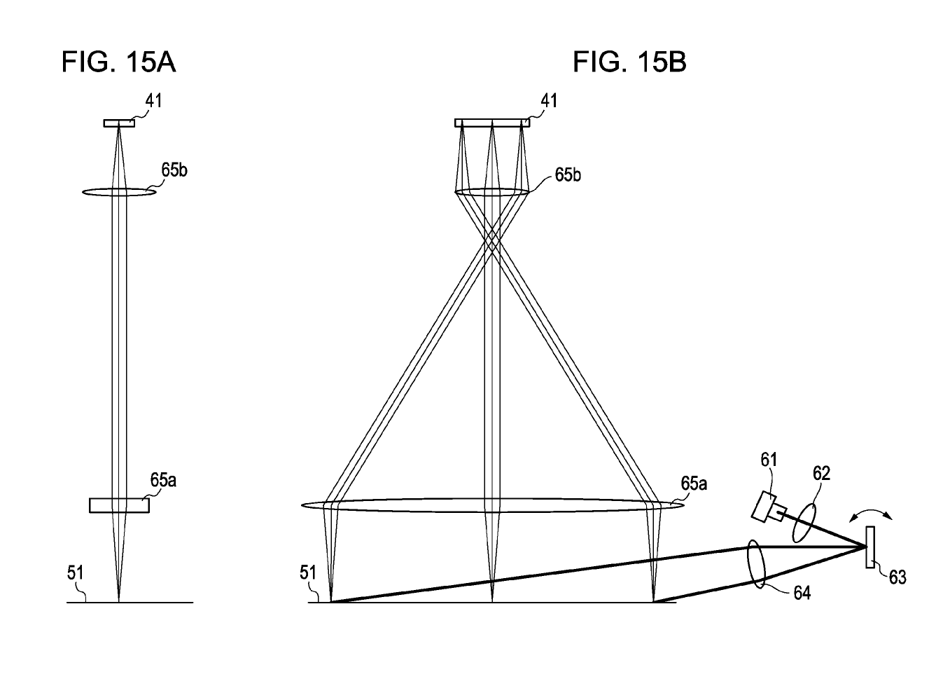

FIG. 15 is a second example of the imaging optical system. FIG. 15A is a side view and FIG. 15B is a front view. In the configuration of FIG. 15, the hologram surface 51 is transferred in the direction perpendicular to the page of FIG. 15. In other words, in the configuration of FIG. 15, the reference light enters so that the reference light has a predetermined incident angle to the direction parallel to the transfer direction. In the same way as the optical system illustrated in FIG. 14, an optical system constituted by the laser light source 61, the collimator lens 62, the galvano mirror 63, the telecentric fθ lenses 64, 65a, and 65b is arranged.

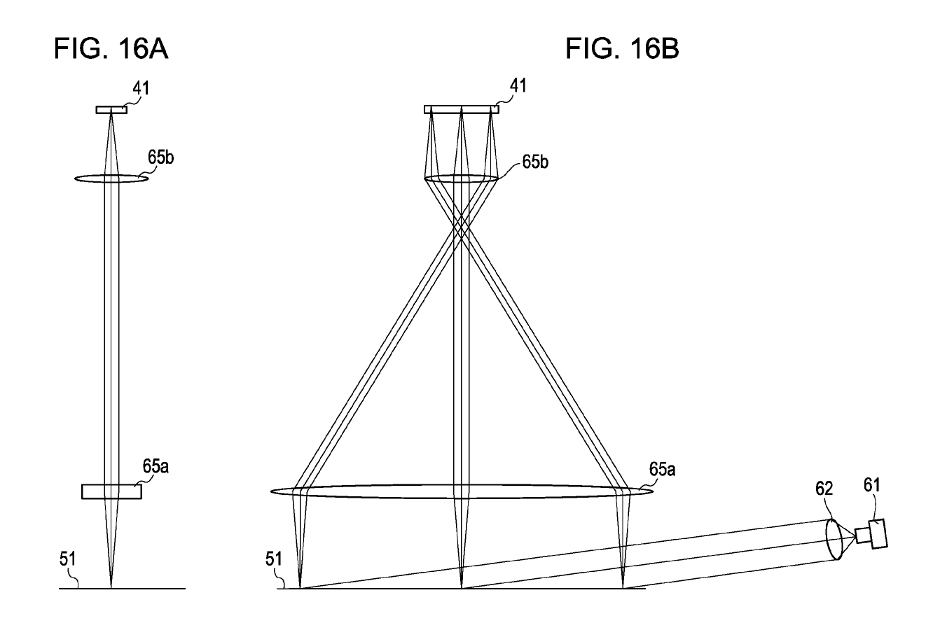

FIG. 16 illustrates a third example of the imaging optical system. The third example illustrates an example in which the light scanning is not performed and the laser light converted into parallel light in advance is obliquely irradiated. When using an LED instead of the laser light source, it is difficult to generate a perfect parallel light, so that it is also difficult to irradiate light over the entire width with the same condition. In this case, by changing a gain and a shatter speed depending on the position in the imaging system, uniformity of the image can be realized. Or, like the first embodiment described above, brightness unevenness of the hologram reproduction image can be corrected by image processing.

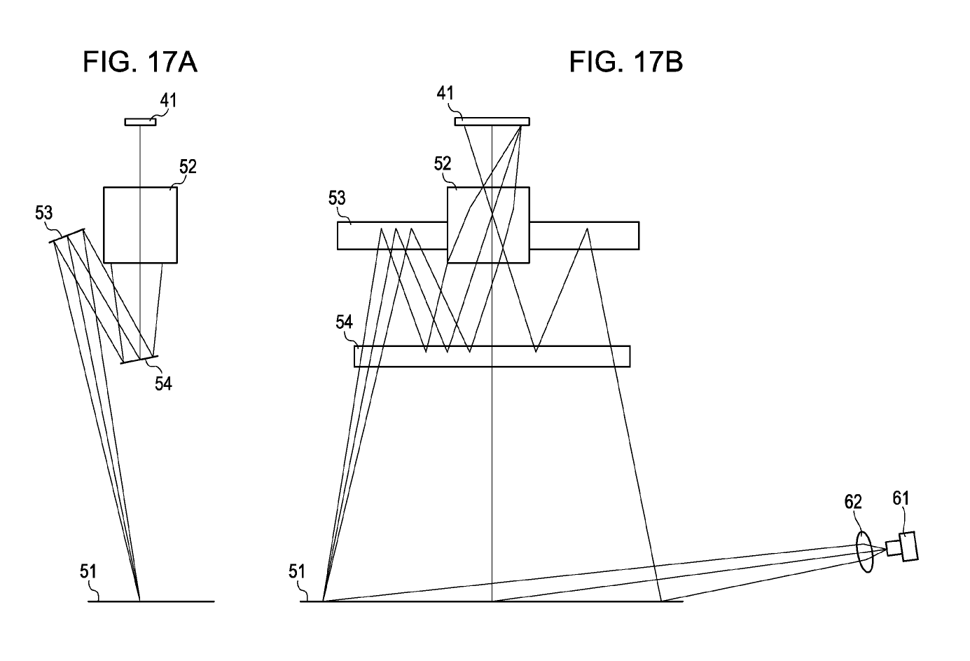

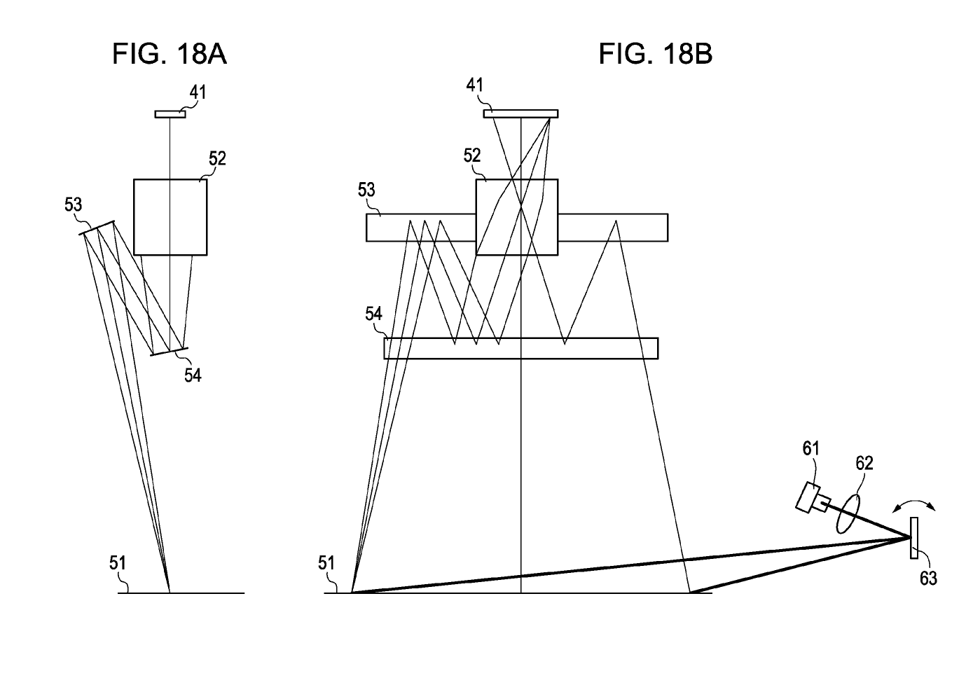

FIGS. 17 and 18 respectively illustrates a fourth example and a fifth example of the imaging optical system in which the non-telecentric lens 52 is used. Ideally, the imaging optical system should be constructed by a so-called telecentric optical system so that the reading can be performed at the same angle over the entire width. However, in such a telecentric optical system, a large lens and a large optical system are used, and hence, the merit of using the non-telecentric lens 52 is great. Even when the non-telecentric lens 52 is used, by constructing an optical system in which the incident angle of the reference light is changed depending on the position, the reading angle can be controlled not to be changed.

### 3. Modified Embodiment

Although specific embodiments to which the present invention is applied has been described, the present invention is not limited to these, and various modifications are possible. For example, as a light source, a laser can be used instead of the LED. Further, a plurality of shutters may be provided to one light source to make a plurality of light sources. Furthermore, the embodiments of the present invention can be applied to reproduction of an image recorded by the holographic stereogram technique.

### DESCRIPTION OF REFERENCE NUMERALS AND SYMBOLS

2 . . . ID information recording process
5 . . . Inspection process
30 . . . Reference light source
40 . . . Reproduction area
41 . . . Imaging sensor
51 . . . Hologram surface
61 . . . Laser light source
63 . . . Galvano mirror
131 . . . Hologram recording film
137 . . . Inspection apparatus
138 . . . Reference light source
L1 to Ln . . . LED
R1 to Rn . . . Area

The present application contains subject matter related to that disclosed in Japanese Priority Patent Application JP 2009-101516 filed in the Japan Patent Office on Apr. 20, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A hologram reproducing and imaging apparatus comprising:
a reference light source configured to be arranged near a hologram recording material on which a hologram is recorded and has an arrangement of a plurality of light sources;
a reference light source drive section configured to drive the plurality of light sources in a time-division manner;
an imaging sensor configured to capture an image of a reproduction area irradiated with reference light from the reference light source and photoelectrically convert the image; and
an image processing section configured to process an imaging signal from the imaging sensor,
wherein partial captured images are obtained by enabling the imaging signal of the area irradiated when the plurality of light sources are turned on, and the partial captured images are combined to be a reproduction image by the image processing section.

2. The hologram reproducing and imaging apparatus according to claim 1, wherein the reference light source is driven so that one of a plurality of adjacent light sources in the plurality of light sources emits light sequentially.

3. The hologram reproducing and imaging apparatus according to claim 1, wherein, in the hologram recording material, a refractive index modulation is recorded in a single layer of material so that another image which is different from and separated from a recorded image is reproduced when a viewpoint is moved in a direction different from the horizontal direction with respect to the normal line.

4. The hologram reproducing and imaging apparatus according to claim 1, wherein the arrangement of a plurality of light sources is one-dimensional.

5. The hologram reproducing and imaging apparatus according to claim 1, wherein the arrangement of a plurality of light sources is two-dimensional.

6. A hologram reproducing and imaging method comprising the steps of:
irradiating a hologram recording material with a reference light by driving a reference light source which is arranged near the hologram recording material on which a hologram is recorded and has an arrangement of a plurality of light sources in a time-division manner;
capturing an image of an reproduction area irradiated with the reference light from the reference light source and photoelectrically converting the image by an imaging sensor,
obtaining partial captured images by enabling an imaging signal of the area irradiated when the plurality of light sources are turned on, and
combining the partial captured images to form a reproduction image.
